(19) United States
(12) Patent Application Publication
(10) Pub. No.: US 2020/0300016 A1
(43) Pub. Date: Sep. 24, 2020

(54) HINGE

(71) Applicant: GLASS VICE HOLDINGS LIMITED, Auckland (NZ)

(72) Inventor: Warwick James ALLEN, Auckland (NZ)

(73) Assignee: GLASS VICE HOLDINGS LIMITED, Auckland (NZ)

(21) Appl. No.: 16/824,278

(22) Filed: Mar. 19, 2020

(30) Foreign Application Priority Data
Mar. 20, 2019 (NZ) 751899

(51) Int. Cl. E05F 3/20

(52) U.S. Cl. CPC E05F 3/20; E05Y 2201/21; E05Y 2900/132

(57) ABSTRACT

A hinge for an access closure panel there being a first mounting assembly comprising a first leaf and second leaf to secure to a door and a second mounting assembly hingingly connected to the first mounting assembly and to secure to a door frame. A linear damper is provided by the first mounting assembly to contact the second mounting assembly and slow the movement of the door before reaching its closed condition. The damper has an operative axis that is at an acute angle to the door.

### CROSS-REFERENCE TO RELATED APPLICATION

This application claims the right of priority to New Zealand Patent Application No. 751899 filed on Mar. 20, 2019, the entirety of the contents of which are hereby incorporated by reference.

### FIELD OF INVENTION

The present invention relates to hinges.

### BACKGROUND

Hinges for doors and gates come in many forms and in some forms the hinges also include a mechanism to slow the motion or dampen the motion of the door as it closes. This can be desirable to prevent the doors from slamming shut rapidly and thereby damaging the door or gate hardware or the door frame or door or gate itself.

Australian Patent AU2017201858 describes a hinge that includes two dampers that act in a direction parallel to the plane of the door or the plane of the panel by which the door is hingingly supported. The dampers are linear dampers that are positioned to become active as the door or gate approaches its closed condition. It will be appreciated from AU2017201858 that the closer the axis of operation of a damper is to passing through the axis of the hinge, the more work the damper has to do to reduce the speed of a door swinging closed. Work, being force times distance, and where the axis of operation of the damper is close to the axis of the hinge the mechanical advantage by the door over the damper that is gained requires for the damper to be very strong in its resistance over a short distance of travel in absorbing the motion. It is therefore desirable to position dampers further away from the axis of the rotation where their effect can be greater. However, this is difficult to achieve in a hinge that is also designed to be relatively compact and of a size to reduce material costs.

Accordingly, it is an object of the present invention to overcome the abovementioned disadvantages and/or to at least provide the public with a useful choice.

### BRIEF DESCRIPTION OF THE INVENTION

In a first aspect the present invention may broadly be said to be a hinge for an access closure panel, the hinge comprising;

a first mounting assembly comprising a first leaf and second leaf connected to said first leaf and adapted to capture therebetween part of and secure to one of said closure panel and a fixed structure that defines part of the access adjacent said closure panel,

a second mounting assembly hingingly connected to the first mounting assembly and comprising a mounting leaf to secure to the other of said closure panel and fixed structure to allow the closure panel to be hingingly supported by said fixed structure to rotate between an access closed condition and an access opened condition,

the first leaf and second leaf each having internal face sides presented parallel to each other to directly or indirectly abut respective face sides of the closure panel or fixed structure,

a linear damper of said first mounting assembly secured to at least one of said first leaf and second leaf and presented in a manner to come into contact with said mounting assembly when the closure panel is approaching the closed condition from an open condition to slow the movement of the closure panel before reaching the closed condition, the damper having an operative axis that is acute to the face sides of the first leaf and second leaf.

In a second aspect the present invention may broadly be said to be a hinge for an access closure panel, the hinge comprising;

a first mounting assembly comprising a first leaf and second leaf connected to said first leaf and adapted to capture therebetween part of and secure to one of said closure panel and a fixed structure that defines part of the access adjacent said closure panel,

a second mounting assembly hingingly connected to the first mounting assembly and comprising a mounting leaf to secure to the other of said closure panel and fixed structure to allow the closure panel to be hingingly supported by said fixed structure to rotate between an access closed condition and an access opened condition,

the first leaf and second leaf each having internal face sides presented parallel to each other to directly or indirectly abut respective face sides of the closure panel or fixed structure,

a linear damper of said first mounting assembly secured to at least one of said first leaf and second leaf and presented in a manner to come into contact with said mounting assembly when the closure panel is approaching the closed condition from an open condition to slow the movement of the closure panel before reaching the closed condition, the damper having an operative axis that projects through the face sides of the first leaf and second leaf.

In a further aspect the present invention may broadly be said to be a hinge for an access closure panel, the hinge comprising;

a first mounting assembly comprising a first leaf and second leaf connected to said first leaf and adapted to capture therebetween part of and secure to one of said closure panel and a fixed structure that defines part of the access adjacent said closure panel,

a second mounting assembly hingingly connected to the first mounting assembly and comprising a mounting leaf to secure to the other of said closure panel and fixed structure to allow the closure panel to be hingingly supported by said fixed structure to rotate between an access closed condition and an access opened condition,

the first leaf and second leaf each having internal face sides presented parallel to each other to directly or indirectly abut respective face sides of the closure panel or fixed structure,

a linear damper of said first mounting assembly secured to at least one of said first leaf and second leaf and presented in a manner to come into contact with said mounting assembly when the closure panel is approaching the closed condition from an open condition to slow the movement of the closure panel before reaching the closed condition, the damper having a body that extends across the face sides of the first leaf and second leaf.

In a further aspect the present invention may be said to be an access providing partition at least part of the partition hingingly supporting an access closure to move between an access closing condition and an access open condition by a hinge as herein before described.

Preferably the access closure panel is a door.

Preferably the door is a glass panel.

Preferably the closure panel comprises two opposed face sides parallel and separated from each other.

Preferably the closure panel comprises two opposed face sides parallel and separated from each other a panel thickness apart.

Preferably the first leaf and second leaf are secured to the closure panel.

Preferably the first leaf and second leaf are secured to the closure panel at each opposed face side respectively of said closure panel.

Preferably the closure panel includes a cut-out between the first leaf and second leaf through which the damper extends between the first leaf and second leaf.

Preferably the damper extends between the first leaf to the second leaf.

Preferably the damper extends from the first leaf to the second leaf.

Preferably the damper extends through the cut-out.

Preferably the damper has a body that extends across the face sides of the first leaf and second leaf.

Preferably the damper has an operative axis that projects through the face sides of the first leaf and second leaf.

Preferably the damper has an operative axis that is acute to the face sides of the first leaf and second leaf.

Preferably the damper is located to said first leaf in a hole of said first leaf.

Preferably the damper is located to said first leaf in a hole of said first leaf in which part of the damper is secured.

Preferably the hole of the first leaf is a blind hole.

Preferably the hole of the first leaf has an opening presented at the face side of the first leaf.

Preferably the hole of the first leaf has only one opening presented at the face side of the first leaf.

Preferably the damper is located to said second leaf in a hole of the second leaf.

Preferably the damper is located to said second leaf in a hole of said second leaf in which part of the damper is secured.

Preferably the hole of the second leaf is a through hole.

Preferably the hole of the second leaf is a through hole having a first opening at the face side of the second leaf and a second opening at a part of the second leaf presented away from the direction that the first face side faces, the damper in part protruding from the second leaf at the second opening.

Preferably at least two dampers are used in said hinge.

Preferably 3 dampers are used in each hinge.

Preferably the damper is secured to one of both of said first leaf and second leaf by virtue of at least one of a snug friction fit in the hole(s) with at least part of the damper, adhesive, mechanical fastening.

Preferably the damper comprises a piston with pushrod and cylinder.

Preferably one of said pushrod and cylinder protrudes from said second leaf at the second opening.

Preferably part of the damper protruding from said second leaf is presented for contact with part of said mounting assembly.

Preferably the part of the mounting assembly to come into contact with the damper is part of the mounting leaf.

Preferably the part of the mounting leaf coming into contact with the damper is not planar.

Preferably the part of the mounting leaf coming into contact with the damper is curved or faceted.

Preferably the mounting assembly comes in and out of contact with the damper.

Preferably the mounting assembly comes into contact as the access closure approaches its closed condition.

Preferably once contact is made with the damper by the mounting leaf and the access closure continues to move to the closed condition, the damper is further compressed.

Preferably once contact is made with the damper by the mounting leaf and the access closure continues to move to the closed condition, the mounting leaf continues to compress the damper.

Preferably the compressing of the damper is in its axial direction.

Preferably once contact is made with the damper by the mounting leaf and the access closure continues to move to the closed condition, the mounting leaf acts as a cam surface sliding over part of the damper.

Preferable the mounting leaf has a cam surface to come into sliding contact with the damper to cause the damper the compress and decompress in its axial direction.

Preferably the cam surface has a lead in region to facilitate initial contact of the mounting leaf with the damper when moving from the open condition to the closed condition of the closure panel.

Preferably the hinge comprises at least one damper.

Preferably the hinge comprises at least two dampers.

Preferably the hinge comprises at least 3 dampers.

Preferably the hinge comprises one damper.

Preferably the hinge comprises two dampers.

Preferably the hinge comprises three dampers.

Preferably where two or more dampers are provided, they are presented parallel each other.

Preferably where two or more dampers are provided, they are presented parallel each other and spaced apart on a notional plane parallel to the axis of rotation of the hinge.

Preferably operational axis of the damper is between 15 and 35 degrees to the normal of a notional plane to which the face sides of the first leaf and second leaf are parallel to.

Preferably operational axis of the damper is between 20 and 30 degrees to the normal of a notional plane to which the face sides of the first leaf and second leaf are parallel to.

Preferably operational axis of the damper is 24 degrees to the normal of a notional plane to which the face sides of the first leaf and second leaf are parallel to

Preferably the cut out is from a side of the closure panel.

Preferably the hinge is mounted at a straight edge of the closure panel, the straight edge including a said cut out. Preferably the cut out is from a side of the fixed structure when of a panel format

Preferably the hinge is mounted at a straight edge of the fixed structure when of a panel format, the straight edge including a said cut out.

Preferable when the first leaf and second leaf are engaged to said fixed structure, the fixed structure is of a panel format.

Preferably the fixed structure and the closure panel are both of a planar panel format.

Preferably the fixed structure and the closure panel are both planar glass panels.

Preferably the mounting assembly includes a lip region that makes contact with the damper as the closure panel approaches the closed condition.

Preferably the lip region laps the second leaf at where the damper projects then the closure panel is in the closed condition so that the lip region obscures the damper from being visible.

Preferably a face of the lip region comes into contact with the damper as the closure panel approaches its closed condition.

Preferably where the hinge includes a plurality of dampers, the face comes into contact with each damper as the closure panel approaches its closed condition.

Preferably when the closure panel is in its closed condition, the lip is received in a rebate of the second leaf and the lip and the second leaf together present a flush looking outer face of the hinge at the second leaf side of the hinge.

Preferably the lip when the closure panel is in the closed condition is substantially parallel the notional plane of the closure panel.

Preferably the lip projects from the fixed structure side of the hinge axis to the closure panel side of the hinge axis.

Preferably the lip projects beyond the edge of the fixed structure to which the mounting assembly is attached.

Preferably at least two hinges are used.

Preferably the damper has a body comprising of a first part and a second part that that can move relative each other in the operative axis direction of the damper.

Preferably the damper has a body comprising a first part and a second part that that can move relative each other in the operative axis direction of the damper between a condition where the damper is expanded and a condition where the damper is contracted/compressed.

Preferably the first part comprises a cylinder and the second part comprises a piston located in the cylinder and piston rod secured to the piston and that extend and retract from the cylinder.

Preferably the piston and piston rod are biased to a position relative the cylinder where damper is in its expanded condition.

In a further aspect the present invention is door or gate supported from a fixed structure by at least one hinge as herein described.

Preferably the hinge is used as part of pool fencing.

Preferably the amount damper projects from the second leaf is adjustable.

Preferably the amount damper projects from the second leaf is adjustable by a threaded fastener.

Preferably the amount damper projects from the second leaf is adjustable by a threaded fastener threadingly engaged to the first leaf.

Preferably the threaded fastener acts on an end of the damper

Preferably the threaded fastener located the end of the damper relative the first leaf.

Preferably the threaded fastener presents a driver region that is able to be engaged by a tool to allow the threaded fastener to be adjusted.

Preferably the threaded fastener is a grub screw.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

The present invention will now be described with reference to the accompanying drawings wherein

FIG. 1 shows a perspective view of a gated fence supporting the gate by two hinges of the present invention,

FIG. 2 is a perspective view of one side of a hinge of the present invention,

FIG. 3 shows the hinge of the present invention in an open condition showing internal parts,

FIG. 4 is a perspective view of FIG. 3 from a different direction,

FIG. 5 is a plan view of the hinge attached to two panels to hinge the two panels relative to each other without showing the damper,

FIG. 6 is a plan view in section of part of the hinge and panels showing the damper,

FIG. 7 shows the hinge of FIG. 6 in an open condition,

FIG. 8 shows a panel of the fence or gate with a cut out to allow for the dampers to project through the cut out,

FIG. 9 shows a plan view of parts of the hinge showing the mounting leaf having a cam surface, and

FIG. 10 shows a plan perspective view of part of the hinge illustrating the damper in position and the hinge attached to a panel.

### DETAILED DESCRIPTION OF THE INVENTION

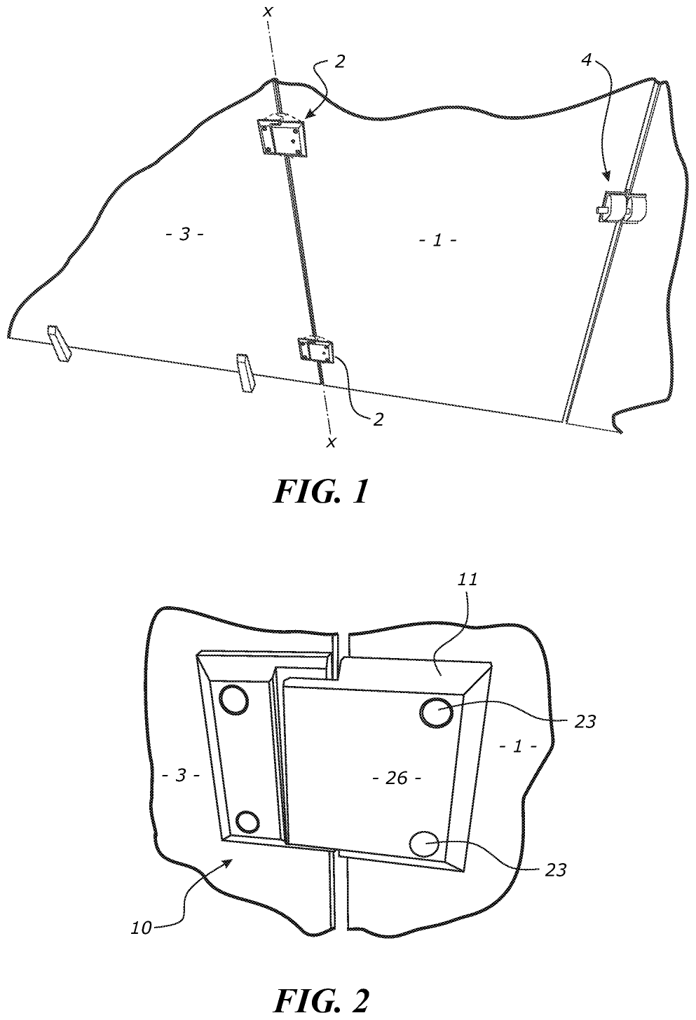

With reference to FIG. 1 there is shown an access closure panel 1 that is supported by two hinges 2 from a fixed structure 3. The hinges allow for the access closure panel 2 to rotate about axis xx relative to the fixed structure 3. In the examples shown in FIG. 1 the access closure panel is preferably a gate such as a pool gate which may be a glass panel. A latch mechanism 4 may be provided for holding the access closure panel in a closed condition. The fixed structure 3 may be or may be part of a partition or fence which includes an access or access way able to be closed by the access closure panel 1. The access closure panel 1 is shown in FIG. 1 in its closed condition closing the access or access way of the partition which the fixed structure 3 forms part of. In the preferred form the fixed structure is also of a panel configuration and may be of a glass panel of the same gauge as the access closure panel 1. In the closed condition the fixed structure panel 3 and the access closure panel 1 are preferably substantially co-planar. In the open condition of the access closure panel the access closure panel is at an angle to the plane of the fixed structure panel 3. The hinge may provide for a range of motion of the access closure panel from its closed condition to its opened condition between 70 to at least 90°.

With reference to FIG. 2 the hinge comprises a first mounting assembly 10 and a second mounting assembly 11. The first mounting assembly 10 as shown in FIG. 2, is able to be secured to the fixed structure. The second mounting assembly 11 is able to be secured to the access closure panel 1. It is also possible to reverse this. The first mounting assembly preferably comprises of a first leaf 12 and a second leaf 13 that are hingingly connected to each other. Such hinging connection may be via the pivot assembly 16 that defines the axis of rotation xx.

The first leaf 12 and second leaf 13 are able to be secured to one of the access closure panel and fixed structure to capture part of the access closure panel and fixed structure therebetween as seen in the drawings. In the drawings the first and second leaf are shown secured to the fixed structure, the fixed structure being in a panel format.

The first and second leaf are spaced apart sufficient to allow for the panel to be captured therebetween in a snug manner. Fasteners 22 may be used to secure the first and second leaf to the fixed structure 3 or to the axis closure panel 1. The fasteners 22 preferably pass through the panel 3. They are preferably threaded fasteners. The panel preferably has holes drilled through it to receive these fasteners. The second mounting assembly 11 is also connected to the mover called pivot assembly 16. This allows for the first mounting assembly and second mounting assembly to be hingingly connected to each other.

The second mounting assembly 11 comprises a mounting leaf 26 that is able to be secured to the other of the access closure panel 1 and fixed structure 3. In the drawing shown the mounting leaf 26 is secured to the access closure panel. Fasteners 23 may be used for such purposes. The second mounting assembly may include a second mounting leaf (not shown) positioned on the other side of the access closure panel. This allows for the axis closure panel to be captured between the mounting leaf 26 and such other second mounting leaf of the second mounting assembly. That may be the second mounting leaf that is directly secured to the pivot assembly 16. As can be seen in FIG. 4 where the access closure panel is in an open condition, the first mounting assembly may comprise of at least one and preferably two or more linear dampers 28.

The first leaf and the second leaf preferably comprise internal face sides 30 and 31 respectively, that face each other and that abut the opposing face sides 36 and 37 respectively of the panel 3. The internal face sides are notionally and operatively substantially planar but may include rebates, recesses, cuts, slots or grooves but in effect are operative for abutting onto, in a loaded distributed manner, to the surfaces 37 and 38 of the access closure panel (or adjacent structure). An insert may be provided such as rubber shim or absorber intermediate of the first and second leafs and the panel 3. Hence the abutting may be indirect.

The dampers 28 are preferably linear dampers and may comprise of two parts 39 and 40. One or other of the two parts 39 and 40 may be a cylinder and piston with piston rod. The piston is able to slide within the cylinder body and the piston rod is attached to the cylinder to project from the cylinder body. The linear damper can hence expand and contract in length along its operative axis cc. In order to reduce the distance ff between the outer faces of the first and second leafs 12 and 13 (which preferably defines the thickness of the hinge thereat) the operative axis cc is preferably not perpendicular to the plane pp of the panel 3 to which the first and second leafs are secured. Instead the operative axis is at an acute angle to the normal to the plane pp. This allows for a longer distance of travel to be catered for in effecting and absorbing and speed reducing force by the damper on the access closure panel as it approaches its closed condition.

In a preferred form the operative angle A of the operative axis cc of the damper is between 15° and 35° and preferably between 20° and 30 ° and preferably 24°.

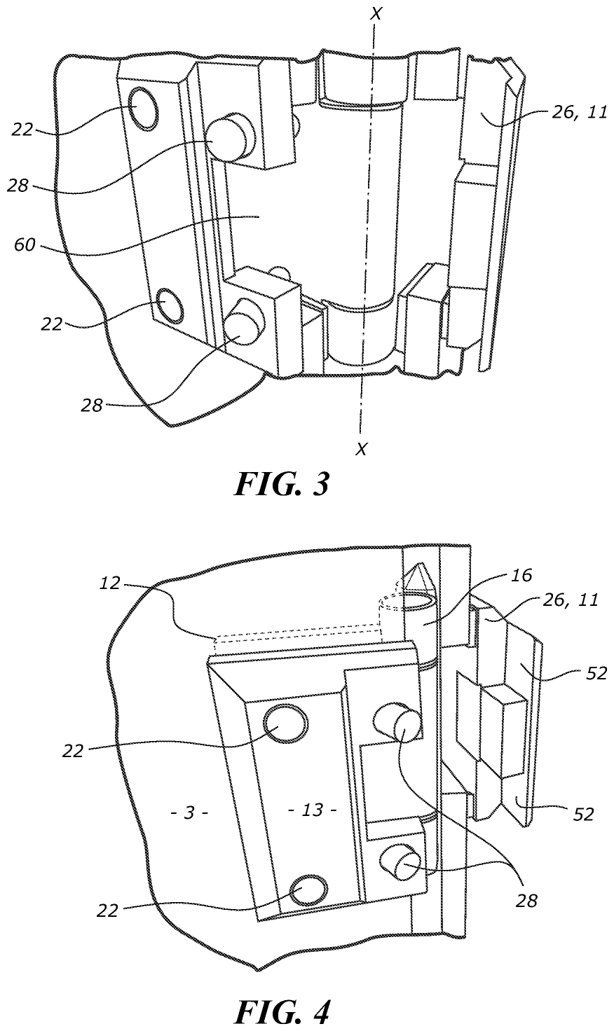

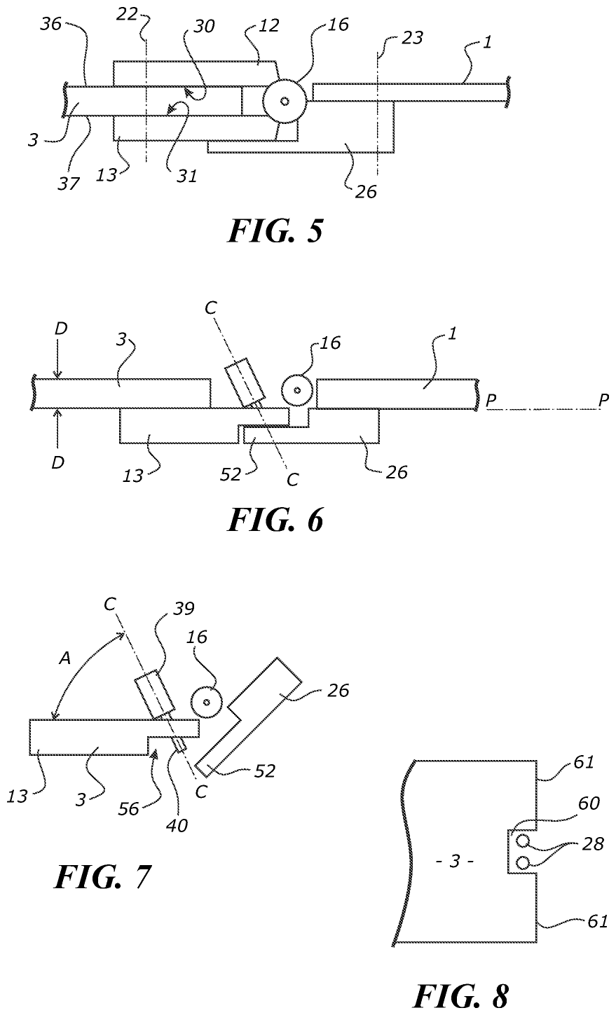

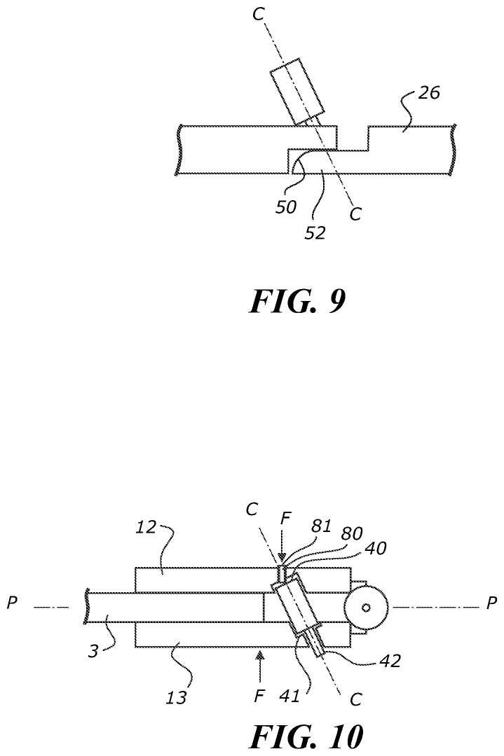

In a preferred form the damper is secured to the first mounting assembly by virtue of being located in at least one of a hole 40 of the first leaf assembly and hole 41 of the second leaf assembly 13. In a preferred form the hole 40 the first leaf 12 is a blind hole as seen in FIG. 10 and the hole of 41 of the second leaf 13 is a through hole. One of the parts of the damper such as the piston rod 42 projects through the through hole 41 of the second leaf 13 when the damper is in its expanded condition so as to present the piston rod for contact by the mounting leaf 26 of the second mounting assembly 11. This is for example shown in FIG. 10 however an alternative is shown in FIGS. 3 and 4 where the cylinder housing projects through the through hole 41 of the second leaf 13 and the piston rod is located at the blind hole 40 of the first leaf 12. In any event it will be appreciated that the damper extends between the first leaf 12 and second leaf 13 and preferably extends from the first leaf 12 through the second leaf 13. The operative axis is seen preferably does not pass through the axis on XX of the hinge so the rotational axis xx of the hinge. Preferably it runs tangential to the rotational axis. The damper is presented for contact by the mounting leaf at a location that is distal from the axis XX. As can be seen with reference to FIGS. 6 and 7, the mounting leaf 26 can move between a position where the mounting leaf is contiguous the leaf 13 and in contact with the damper and a position where it is released from the damper.

The mounting leaf 26 is able to come into contact with the damper as the closure panel approaches its closed condition. In order to ensure a smooth initial engagement the mounting leaf 26 preferably includes a non-planar region 50 that allows for a smooth transition of engagement of the mounting leaf with the damper. The non-planar region effectively acts as a cam surface both pressing down onto and sliding over the end of the damper as it engages and as the panel moves to its closed condition. The mounting leaf 26 presents the surface as part of a lip 52 of the mounting leaf 26. The lip projects sufficiently to preferably become co-planar or parallel to the plane of the second leaf 13. In the example shown in FIG. 6 the second leaf 13 includes a rebate 56 into which the lip 52 of the mountain leaf is able to locate. This helps to present a substantial flush exterior of the hinge on the second leaf side of the hinge. In a preferred form the damper projects out from the second leaf 13 at the rebate 56. The panel 3 may require for the provision of a cut out 60 along its each 61 at where the hinge is to locate to allow for the dampers 28 to pass from one side of the panel 3 to the other side. The cut out 60 is preferably of a sufficient size to accommodate the dampers. This allows the dampers to pass through the thickness of the panel and take advantage of the overall thickness of the hinge to present itself for absorbing motion, rather than of the thickness of just one leaf.

In a further embodiment, the amount the damper 28 projects from the second leaf 13 is adjustable. In one embodiment, the adjustability is provided by a threaded fastener 80. The threaded fastener may threadingly engage to the first leaf 12. Preferably the threaded fastener 80 acts on an end of the damper 28. In one embodiment, the threaded fastener 80 is located at the end of the damper 28 relative the first leaf 12. The threaded fastener 80 presents a driver region 81 that is able to be engaged by a tool to allow the threaded 80 fastener to be adjusted. Preferably the threaded fastener is a grub screw 80.

1. A hinge for an access closure panel, the hinge comprising:
a first mounting assembly comprising a first leaf and second leaf connected to said first leaf and adapted to capture therebetween part of and secure to one of said closure panel and a fixed structure that defines part of the access adjacent said closure panel,
a second mounting assembly hingingly connected to the first mounting assembly and comprising a mounting leaf to secure to the other of said closure panel and fixed structure to allow the closure panel to be hingingly supported by said fixed structure to rotate between an access closed condition and an access opened condition,
the first leaf and second leaf each having internal face sides presented parallel to each other to directly or indirectly abut respective face sides of the closure panel or fixed structure,
a linear damper of said first mounting assembly secured to at least one of said first leaf and second leaf and presented in a manner to come into operative contact with said second mounting assembly when the closure panel is approaching the closed condition from an open condition to slow the movement of the closure panel before reaching the closed condition, the damper having an operative axis that is acute to the face sides of the first leaf and second leaf.

2. A hinge for an access closure panel, the hinge comprising:
a first mounting assembly comprising a first leaf and second leaf connected to said first leaf and adapted to capture therebetween part of and secure to one of said closure panel and a fixed structure that defines part of the access adjacent said closure panel,
a second mounting assembly hingingly connected to the first mounting assembly and comprising a mounting leaf to secure to the other of said closure panel and fixed structure to allow the closure panel to be hingingly supported by said fixed structure to rotate between an access closed condition and an access opened condition,
the first leaf and second leaf each having internal face sides presented parallel to each other to directly or indirectly abut respective face sides of the closure panel or fixed structure,
a linear damper of said first mounting assembly secured to at least one of said first leaf and second leaf and presented in a manner to come into operative contact with said second mounting assembly when the closure panel is approaching the closed condition from an open condition to slow the movement of the closure panel before reaching the closed condition, the damper having an operative axis that projects through the face sides of the first leaf and second leaf.

3. The hinge as claimed in claim 1 wherein the damper extends between the first leaf to the second leaf.

4. The hinge as claimed in claim 1 wherein the damper extends from the first leaf to the second leaf.

5. The hinge as claimed in claim 1 wherein the damper has an operative axis that is acute to the face sides of the first leaf and second leaf.

6. The hinge as claimed in claim 1 wherein the damper is located to said first leaf in a hole of said first leaf in which part of the damper is secured.

7. The hinge as claimed in claim 6 wherein the hole of the first leaf is a blind hole.

8. The hinge as claimed in claim 1 wherein at least two dampers are used in said hinge.

9. The hinge as claimed in claim 1 wherein the part of the mounting assembly to come into contact with the damper is part of the mounting leaf and the part of the mounting leaf coming into contact with the damper is not planar.

10. The hinge as claimed in claim 9 wherein the part of the mounting leaf coming into contact with the damper is curved or faceted.

11. The hinge as claimed in claim 10 wherein once contact is made with the damper by the mounting leaf and the access closure continues to move to the closed condition, the mounting leaf acts as a cam surface sliding over part of the damper.

12. The hinge as claimed in claim 1 wherein the mounting leaf has a cam surface to come into sliding contact with the damper to cause the damper the compress and decompress in its axial direction.

13. The hinge as claimed in claim 12 wherein the cam surface has a lead in region to facilitate initial contact of the mounting leaf with the damper when moving from the open condition to the closed condition of the closure panel.

14. The hinge as claimed in claim 13 wherein operational axis of the damper is between 20 and 30 degrees to the normal of a notional plane to which the face sides of the first leaf and second leaf are parallel to.

15. An access providing partition at least part of the partition hingingly supporting an access closure to move between an access closing condition and an access open condition by a hinge as claimed in claim 1.

16. The access providing partition as claimed in claim 15 wherein the access closure panel is a door.

17. The access providing partition as claimed in claim 16 wherein the door is a glass panel.

18. The access providing partition as claimed in claim 16 wherein the closure panel comprises two opposed face sides parallel and separated from each other.

19. The access providing partition as claimed in claim 15 wherein the first leaf and second leaf are secured to the closure panel.

20. The access providing partition as claimed in claim 15 wherein the damper extends between the first leaf to the second leaf.

21. The access providing partition as claimed in claim 15 wherein the damper extends from the first leaf to the second leaf.

22. The access providing partition as claimed in claim 15 wherein closure panel includes a cut-out between the first leaf and second leaf through which the damper extends between the first leaf and second leaf and the damper extends through the cut-out.
